(19) United States
(12) Patent Application Publication
(10) Pub. No.: US 2025/0385479 A1
(43) Pub. Date: Dec. 18, 2025

(54) CRIMPING HAND TOOL WITH STRIPPING ACCESSORY

(71) Applicant: JETOOL CORP., New Taipei City (TW)

(72) Inventor: Yi Ching Kao, New Taipei City (TW)

(73) Assignee: JETOOL CORP., New Taipei City (TW)

(21) Appl. No.: 18/822,258

(22) Filed: Sep. 1, 2024

(30) Foreign Application Priority Data
Jun. 17, 2024 (TW) 113206315

(51) Int. Cl. H01R 43/042

(52) U.S. Cl. CPC H01R 43/0421

(57) ABSTRACT

A crimping hand tool including a first handle, a second handle, a crimping head, a toggle linkage assembly, and a stripping accessory is provided. The first handle pivoted to the second handle has a receiving slot and a crimping slot facing away from each other. The crimping head is slidably disposed in the first handle. The toggle linkage assembly connects the first handle, the second handle, and the crimping head. The first handle pivots relative to the second handle to drive the crimping head to move in or out of the crimping slot via the toggle linkage assembly. The stripping accessory is detachably disposed in the receiving slot.

### CROSS-REFERENCE TO RELATED APPLICATION

This application claims the priority benefit of Taiwan application serial no. 113206315, filed on Jun. 17, 2024. The entirety of the above-mentioned patent application is hereby incorporated by reference herein and made a part of this specification.

### BACKGROUND

### Technical Field

The disclosure relates to a crimping hand tool, and in particular to a crimping hand tool with a stripping accessory.

### Description of Related Art

Coaxial cable is named because the two conductors in the coaxial cable share a central axis. The coaxial cable is often used in signal transmission, cable television systems, etc. The coaxial cable has a wide range of uses, so how to crimping and combining coaxial terminals with coaxial cables has become an important issue.

In the existing crimping process, the wires must undergo cutting, stripping, and other pre-processes before they can be connected (crimped) to the connection structure. For these pre-processes, there are many different hand tools in the existing technologies. As a result, the operator needs to carry these different hand tools in order to perform corresponding processing steps on the cables one by one, which often causes inconvenience to the operator.

### SUMMARY

The disclosure provides a crimping hand tool with a stripping accessory, which integrates stripping and crimping tools into an integrated structure by providing accommodating space through the handle.

The crimping hand tool with the stripping accessory of the disclosure includes a first handle, a second handle, a crimping head, a toggle linkage assembly, and a stripping accessory. The first handle has a crimping slot and a receiving slot facing away from each other. The second handle is pivotally connected to the first handle. The crimping head is slidably disposed on the first handle. The toggle linkage assembly connects the first handle, the second handle, and the crimping head. The first handle pivots relative to the second handle to drive the crimping head to move in or out of the crimping slot through the toggle linkage assembly. The stripping accessory is detachably disposed in the receiving slot.

Based on the above, the first handle has both the crimping slot for the crimping head to enter and exit and the receiving slot for disposing the stripping accessory. Therefore, the structure and space of the first handle are effectively utilized, and the crimping tool and the stripping assembly are integrated into the same structure. In this way, the operator only needs to hold the crimping hand tool provided in the disclosure to pre-process the wires by the stripping accessories, and then crimp the wires with the connection structure by the crimping tool so that the effort and time required for tool replacement can be saved, thereby improving the convenience and efficiency of cable crimping operations.

### BRIEF DESCRIPTION OF THE DRAWINGS

FIG. 1 is a schematic view of a crimping hand tool with a stripping accessory according to an embodiment of the disclosure.

FIG. 2 is an exploded schematic view of the crimping hand tool of FIG. 1.

FIG. 3 is a schematic view of the operation of the stripping accessory of FIG. 2.

FIGS. 4A to 4C are schematic view s of a cable processing process.

FIGS. 5A and 5B are schematic views of a crimping hand tool performing a cable processing.

FIGS. 6A and 6B are side views of the crimping hand tool of FIGS. 5A and 5B respectively.

### DESCRIPTION OF THE EMBODIMENTS

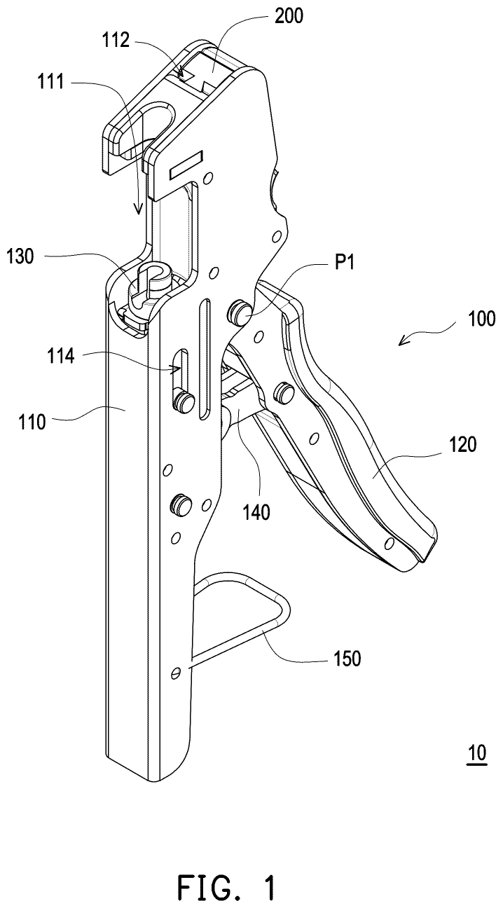

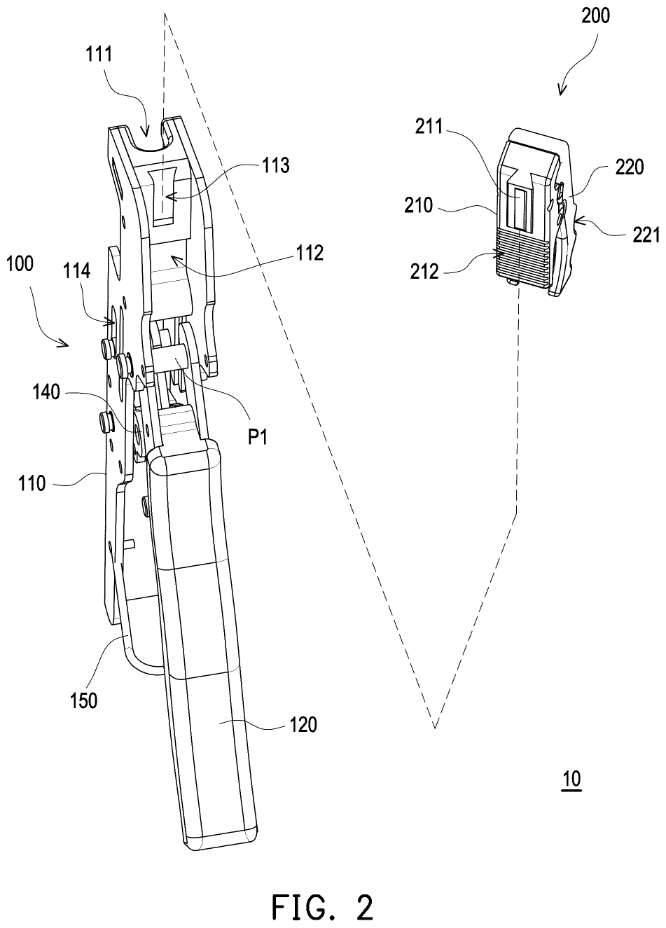

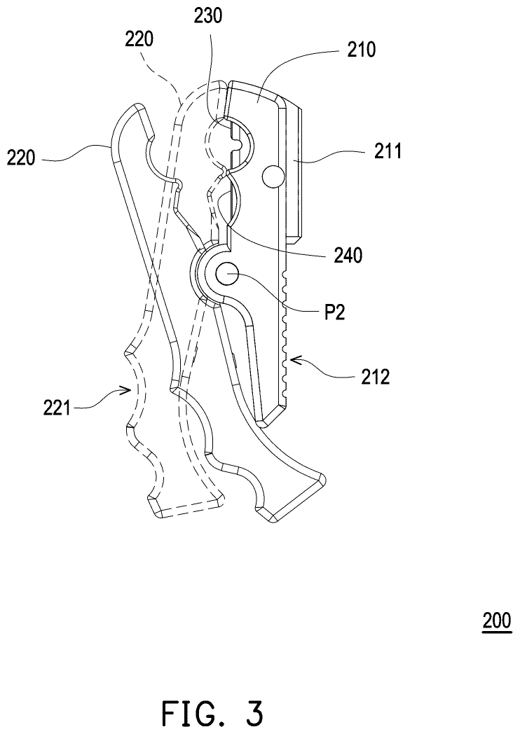

FIG. 1 is a schematic view of a crimping hand tool with a stripping accessory according to an embodiment of the disclosure. FIG. 2 is an exploded schematic view of the crimping hand tool of FIG. 1. FIG. 3 is a schematic view of the operation of the stripping accessory of FIG. 2. Please refer to FIGS. 1 to 3 at the same time. In this embodiment, a crimping hand tool 10 with a stripping accessory (hereinafter referred to as the crimping hand tool 10) includes a crimping assembly 100 and a stripping accessory 200. Further, the crimping assembly 100 includes a first handle 110, a second handle 120, a crimping head 130, and a toggle linkage assembly 140. The first handle 110 has a crimping slot 111 and a receiving slot 112 facing away from each other. The second handle 120 is pivotally connected to the first handle 110 through a pivot axis P1. The crimping head 130 is slidably disposed on the first handle 110. The toggle linkage assembly 140 connects the first handle 110, the second handle 120, and the crimping head 130. The first handle 110 pivots relative to the second handle 120 to drive the crimping head 130 to move in or out of the crimping slot 111 via the toggle linkage assembly 140. The stripping accessory 200 is detachably disposed in the receiving slot 112.

As shown in FIGS. 2 and 3, the stripping accessory 200 has a special-shaped block 211. Here, a dovetail block is used as an example. The first handle 110 has a special-shaped slot 113 located in the receiving slot 112. Here, a dovetail slot is used as an example. The contours of the special-shaped block 211 and the special-shaped slot 113 are adapted to each other. Through the special-shaped block 211 sliding into and being clamped in the special-shaped slot 113, the stripping accessory 200 is disposed in the receiving slot 112 of the first handle 110. In another embodiment not shown, the stripping accessory has the special-shaped slot, and the first handle has the special-shaped block, which can also achieve the assembly effect of allowing the first handle to accommodate the stripping accessory. Here, a pivot joint between the first handle 110 and the second handle 120 (i.e., the pivot axis P1) is located on a side of the receiving slot 112.

Furthermore, the stripping accessory 200 of this embodiment includes a third handle 210, a fourth handle 220, and a first cutter 230. The third handle 210 and the fourth handle 220 are pivotally connected to each other through a pivot axis P2 and form a clothespin structure. That is, an operator applies force on driving parts 212 and 221 to pivot each other. An additional torsional spring (not shown) may be disposed at the pivot axis P2 to facilitate reset. The third handle 210 has the special-shaped block 211. The first cutter 230 is disposed on the third handle 210 and faces away from the special-shaped block 211. When receiving the force, the third handle 210 and the fourth handle 220 pivot and allow the first cutter 230 to move away from the fourth handle 220. After the operator releases the force, the first cutter 230 may be moved toward the fourth handle 220 through an elastic force of the torsional spring.

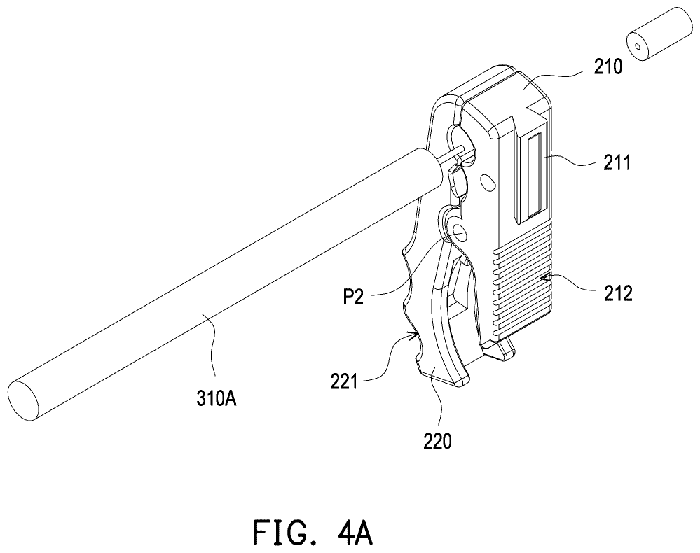

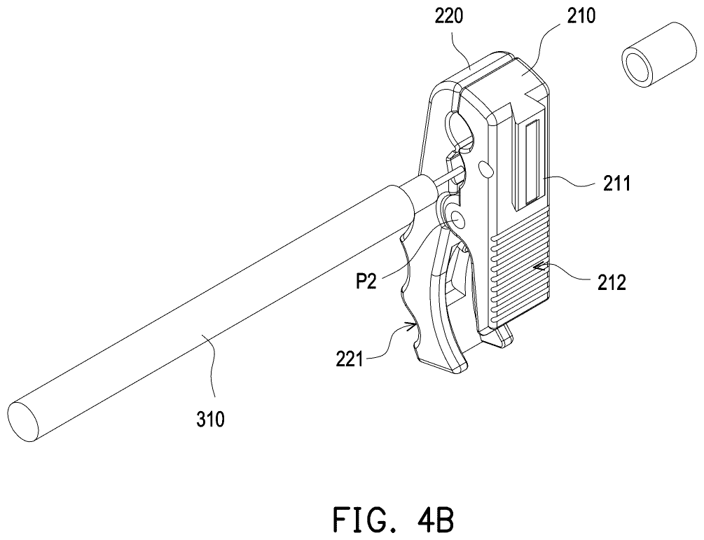

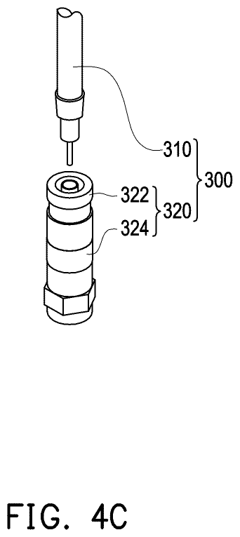

FIGS. 4A to 4C are schematic views of a cable processing process. Please refer to FIG. 4A to FIG. 4C one by one to better understand the processing process. First, in FIG. 4A, the operator applies force on the driving parts 212 and 221 to place a cable in an initial state into a slot structure corresponding to the first cutter 230, and then the operator releases the force to allow the cable to be clamped by the third handle 210 and the fourth handle 220 and allows the first cutter 230 to cut into the corresponding part of the cable at the same time. The operator may cut and peel off the corresponding part by rotating the stripping accessory 200 relative to a cable 310A, thereby forming the cable 310A. Here, as shown in FIG. 4A, for example, a core of the cable 310A is retained, and an inner insulation layer and an aluminum foil covering layer are cut off and peeled off.

Next, please refer to FIG. 3 and FIG. 4B at the same time. In this embodiment, the stripping accessory 200 further includes a second cutter 240, which is disposed on the third handle 210. The first cutter 230 and the second cutter 240 are located on the same side of a pivot point of the third handle 210 and the fourth handle 220 (i.e., the pivot axis P2). Accordingly, the operator repeats the similar operations, applying force on the driving parts 212 and 221 to move the second cutter 240 away from the fourth handle 220, and then releasing the force, allowing the cable 310A to be clamped by the second cutter 240 and the fourth handle 220, allowing the second cutter 240 to cut into a specific part of the cable 310A, and performing the rotating action, so that the specific part may be cut off and peeled off. In this step, an outer insulation layer is further cut off to complete a cable 310.

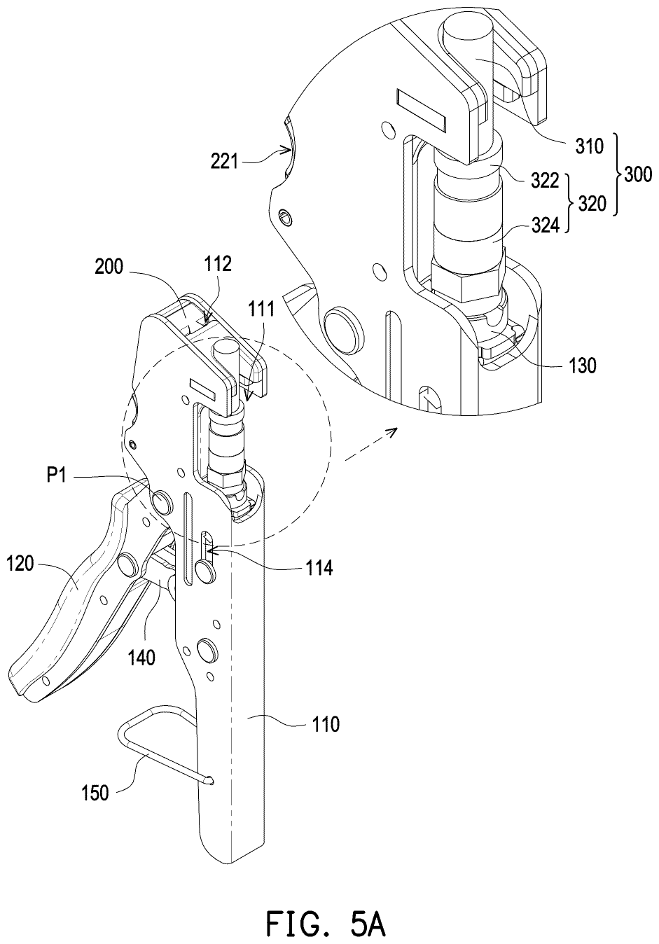

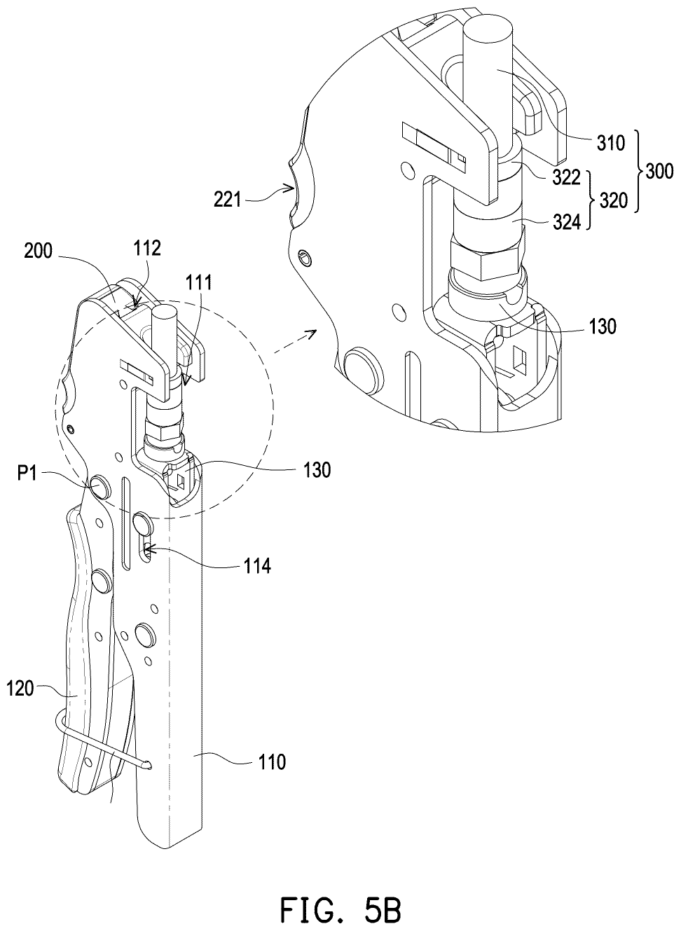

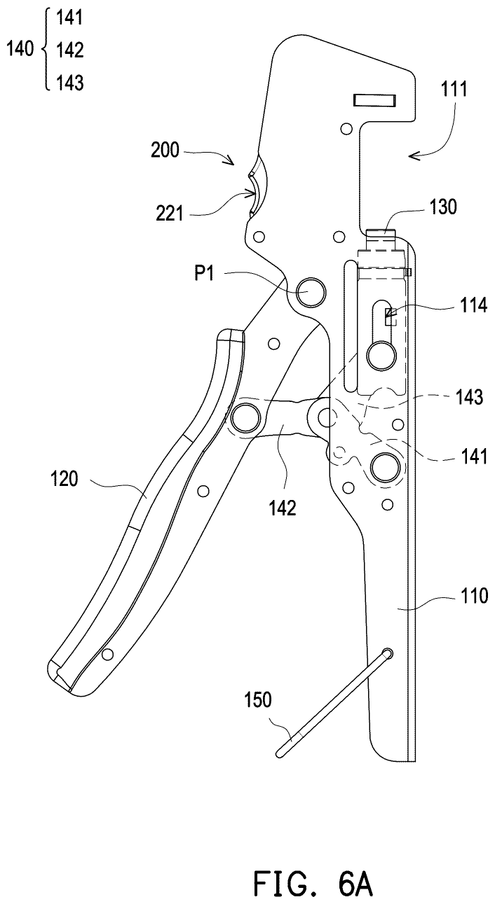

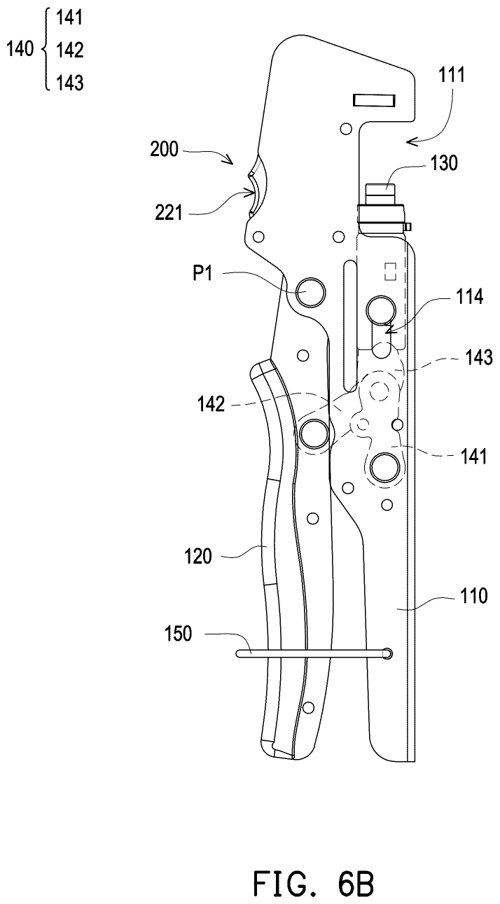

Then, as shown in FIG. 4C, after the cable 310 and a coaxial terminal 320 are placed together, the two may be crimped and combined by the crimping assembly 100. FIGS. 5A and 5B are schematic views of a crimping hand tool performing cable processing. FIGS. 6A and 6B are side views of the crimping hand tool of FIGS. 5A and 5B respectively. Referring to FIGS. 5A and 6A, the toggle linkage assembly 140 of this embodiment includes a first connecting rod 141, a second connecting rod 142, and a third connecting rod 143 that are jointly pivoted at one place. The first connecting rod 141 is further pivotally connected to the first handle 110. The second connecting rod 142 is further pivotally connected to the second handle 120. The third connecting rod 143 is further pivotally connected to the crimping head 130. The first handle 110 further has a sliding slot 114. The part of the third connecting rod 143 that is pivotally connected to the crimping head 130 is further movably coupled to the sliding slot 114. An extending direction of the sliding slot 114 is consistent with a sliding direction of the crimping head 130 on the first handle 110.

Accordingly, first, as shown in FIG. 5A and FIG. 6A, the cable 310 and the coaxial terminal 320 are placed into the crimping slot 111 at the same time, and a fixing part 324 of the coaxial terminal 320 abuts against the crimping head 130 (at the same time, the first handle 110 also has a protrusion on an inner surface of a pair of side walls of the crimping slot 111 for abutting against a clamping part 322 of the coaxial terminal 320 when the operator applies force for crimping). Next, the operator applies force on the first handle 110 and the second handle 120 to allow the two to pivot and approach each other. At the beginning of the process, the crimping head 130 pushes the coaxial terminal 320 to move simultaneously (as shown in the Figure, moves upward). Then, as shown in FIG. 5B and FIG. 6B, after the clamping part 322 abuts the protrusion, and the operator continues to apply force, the clamping part 322 may be threaded onto the fixed part 324 through the crimping head 130, and allow the cable 310 to be crimped onto the fixing part 324 and electrically connected thereto.

In addition, the crimping assembly 100 of this embodiment further includes a stop ring 150 that is pivoted on the first handle 110 to limit the second handle 120 to a crimping position (as shown in FIGS. 5B and 6B) or release the second handle 120 (as shown in FIGS. 5A and 6A) when the second handle 120 pivots and approaches the first handle 110.

To sum up, in the embodiments of the disclosure, the first handle has both the crimping slot for the crimping head to enter and exit and the receiving slot for disposing the stripping accessories, so the structure and space of the first handle are effectively utilized, and the crimping tool and the stripping assembly are integrated into the same structure. In an embodiment, the first handle is provided with the special-shaped slot in the receiving slot, so that the stripping assembly has the special-shaped block. Thereby, the stripping assembly may be assembled into the first handle through the special-shaped block sliding in and being clamped in the special-shaped slot.

In this way, the operator only needs to hold the crimping hand tool provided in the disclosure to pre-process the wires by the stripping accessories, and then crimp the wires with the connection structure by the crimping tool so that the effort and time required for tool replacement can be saved, thereby improving the convenience and efficiency of cable crimping operations.

What is claimed is:

1. A crimping hand tool with a stripping accessory, comprising:
a first handle, having a crimping slot and a receiving slot facing away from each other;
a second handle, pivotally connected to the first handle;
a crimping head, slidably disposed on the first handle;
a toggle linkage assembly, connecting the first handle, the second handle, and the crimping head, wherein the first handle pivots relative to the second handle to drive the crimping head to move in or out of the crimping slot via the toggle linkage assembly; and
a stripping accessory, detachably disposed in the receiving slot.

2. The crimping hand tool with the stripping accessory according to claim 1, wherein one of the stripping accessory and the first handle has a special-shaped block, another one of the stripping accessory and the first handle has a special-shaped slot, the special-shaped block is adapted to the special-shaped slot, and the stripping accessory is disposed into the receiving slot of the first handle through the special-shaped block sliding and being clamped into the special-shaped slot.

3. The crimping hand tool with the stripping accessory according to claim 2, wherein the first handle has the special-shaped slot, the stripping accessory has the special-shaped block, and the special-shaped slot is located in the receiving slot.

4. The crimping hand tool with the stripping accessory according to claim 1, wherein the stripping accessory comprises:
a third handle;
a fourth handle, pivotally connected to the third handle to form a clothespin structure; and
a first cutter, configured on the third handle.

5. The crimping hand tool with the stripping accessory according to claim 4, further comprising a second cutter, configured on the third handle, wherein the first cutter and the second cutter are located on the same side of a pivot joint between the third handle and the fourth handle.

6. The crimping hand tool with the stripping accessory according to claim 1, wherein the toggle linkage assembly comprises a first connecting rod, a second connecting rod, and a third connecting rod that are pivotally connected to one place, the first connecting rod is further pivotally connected to the first handle, the second connecting rod is further pivotally connected to the second handle, and the third connecting rod is further pivotally connected to the crimping head.

7. The crimping hand tool with the stripping accessory according to claim 6, wherein the first handle further has a sliding slot, and a part of the third connecting rod pivotally connected to the crimping head is further movably coupled to the sliding slot.

8. The crimping hand tool with the stripping accessory according to claim 7, wherein a extending direction of the sliding slot is consistent with a sliding direction of the crimping head on the first handle.

9. The crimping hand tool with the stripping accessory according to claim 1, further comprising a stop ring, pivoted on the first handle to limit the second handle or release the second handle when the second handle pivots and approaches the first handle.

10. The crimping hand tool with the stripping accessory according to claim 1, wherein a pivot joint between the first handle and the second handle is located on a side of the receiving slot.
